(19) United States
(12) Patent Application Publication
(10) Pub. No.: US 2017/0265022 A1
(43) Pub. Date: Sep. 14, 2017

(54) METHOD AND APPARATUS FOR PROVIDING PORTABLE TELEMATICS SERVICES

(71) Applicant: FORD GLOBAL TECHNOLOGIES, LLC, Dearborn, MI (US)

(72) Inventors: Oliver LEI, Windsor (CA); Allen R. MURRAY, Lake Orion, MI (US)

(21) Appl. No.: 15/067,837

(22) Filed: Mar. 11, 2016

(51) Int. Cl. H04W 4/00; H04W 8/00; H04W 8/18; H04B 1/3822

(52) U.S. Cl. CPC H04W 4/008; H04B 1/3822; H04W 8/005; H04W 8/18

(57) ABSTRACT

A processor may be configured to detect an electronic tag in proximity to a vehicle wireless receiver. The processor may also be configured to wirelessly receive communication provider account information from the electronic tag via the receiver. The processor may be additionally configured to provide the communication provider account information to a vehicle telematics module, including an onboard modem to enable provision of in-vehicle telematics services, through the modem, using the communication provider account information.

### TECHNICAL FIELD

The illustrative embodiments generally relate to a method and apparatus for providing portable telematics services.

### BACKGROUND

Telematics systems provide connectivity for vehicles, allowing them to communicate with remote sources (servers, the Internet, personal computers, smart phones, etc.) to exchange data. This can be useful for a variety of applications, including, but not limited to, navigation, content delivery, vehicle software updates, vehicle data reports (sensor reports, condition reports, etc.), recall notification and any other process that involves the exchange of data with a remote source. Currently, telematics services are tied to a particular vehicle. Since the telematics module is installed in the vehicle, and because it leverages vehicle hardware, a user can connect to the telematics services through that vehicle, but if the user gets into a different vehicle, the user cannot “bring the telematics with them.” At best, the user could pair a phone with a telematics system in the new vehicle, and use the phone for connectivity, but this requires both the presence of the phone and the pairing of the phone.

### SUMMARY

In a first illustrative embodiment, a system includes a processor configured to enable a vehicle modem to provide communication for vehicle telematics services, utilizing communication provider account information wirelessly provided to the processor from an electronic tag, through a wireless receiver.

In a second illustrative embodiment, a computer-implemented method includes detecting an electronic tag in proximity to a vehicle wireless receiver. The method also includes wirelessly receiving communication provider account information from the electronic tag via the receiver. The method further includes providing the communication provider account information to a vehicle telematics module, including an onboard modem and providing in-vehicle telematics services, through the modem, using the communication provider account information.

In a third illustrative embodiment, a non-transitory computer-readable storage medium stores instructions which, when executed by a processor, cause the processor to perform a method including wirelessly receiving communication provider account information from an electronic tag in detectable proximity to a vehicle wireless receiver. The method also includes providing the communication provider account information to a vehicle telematics module, including an onboard modem. The method further includes providing in-vehicle telematics services, through the modem, using the communication provider account information and deleting the communication provider account information from a vehicle memory, upon detection of a predefined deletion condition.

### BRIEF DESCRIPTION OF THE DRAWINGS

FIG. 1 shows an illustrative vehicle computing system;

FIG. 2 shows an illustrative vehicle setup, including a telematics tag;

FIG. 3 shows an illustrative process for telematics enablement in a vehicle; and

FIG. 4 shows an illustrative telematics disablement process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

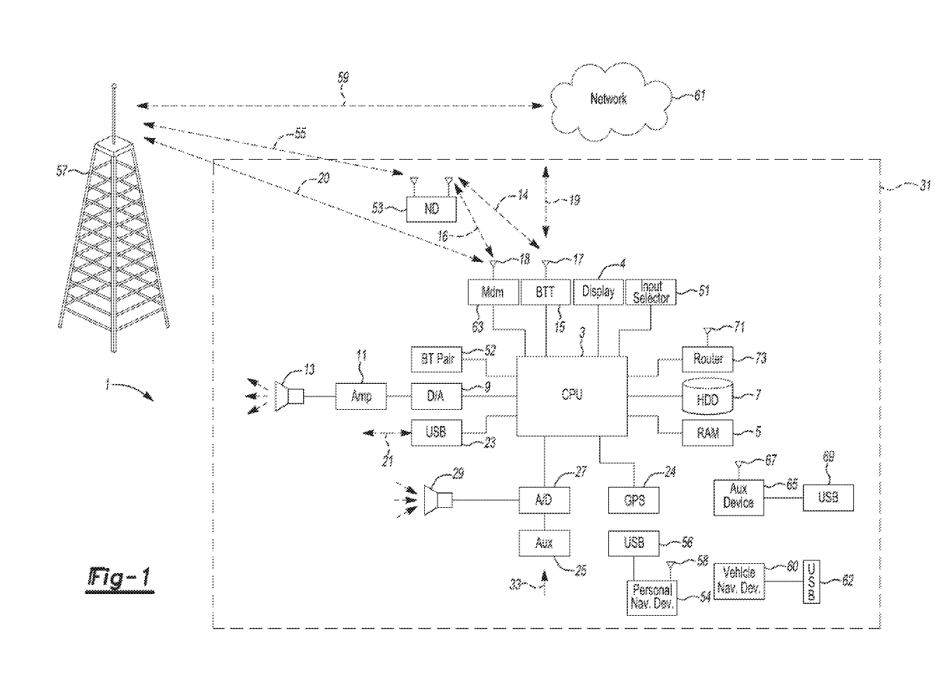

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE .11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

In the present paradigm for telematics services, telematics are tied to a particular vehicle, through inclusion of the telematics unit and any associated modem being installed in a fixed manner within the vehicle. While users may use a paired cellular phone to connect to a remote source, as the telematics unit may leverage the phone's connection capabilities, this does require the phone to be paired to the vehicle. Often, upon pairing, data is downloaded from the phone, such as, but not limited to, a user contact list, user profile data, etc. The user may not want to download such a list, profile data or other information to a vehicle which the user does not own, such as a taxi, UBER vehicle, rideshared vehicle, etc. Also, such a model will leverage the data-plan from a user's phone, and the user may not wish to use the phone-data plan, especially if a significant amount of data may be transferred.

Further, it is possible that a certain user will have features (such as navigation, for example) associated with a particular telematics plan. Other possibilities include unlimited data for vehicle communication, or a remote account associated with a plan, wherein useful user data is remotely stored and accessible (such as, but not limited to, user profile data, user drive settings, remote contact storage, etc.). If the user can access this remote account without pairing a phone, the user may be able to prevent download of this or similar information to a vehicle which the user will use on a very limited basis. This can also help prevent the data from being permanently or long-term stored on the limited-use vehicle.

In the illustrative embodiments, the user is provided with the capability to “port” the telematics service from one vehicle to another. Through the use of an electronic tag (which could be carried on a keychain or in a pocket, or even attached to or made part of, for example, a smart watch or smart phone), the user can enable telematics services in a limited-use vehicle, allowing the user to utilize the on-board modem and telematics services, without having to actually pair a phone to the vehicle. This is also useful because the user may not want to ask the driver (in a vehicle-for-hire situation) to go through a cumbersome pairing process, avoiding any payment for time spent pairing, objections the driver may have, and delays in the journey, among other things. Instead, the user can simply tap the electronic tag to a provided receiver (or otherwise instruct the tag to communicate with the receiver), and the user's account information can be utilized to leverage a modem already existing in the vehicle to obtain telematics services. This can essentially cause the vehicle telematics services to perform as if they were those of the user's long-term use vehicle, including using personal, remotely stored information, account benefits (navigation, unlimited data, etc.), and generally providing the user to use telematics services without having paired a phone.

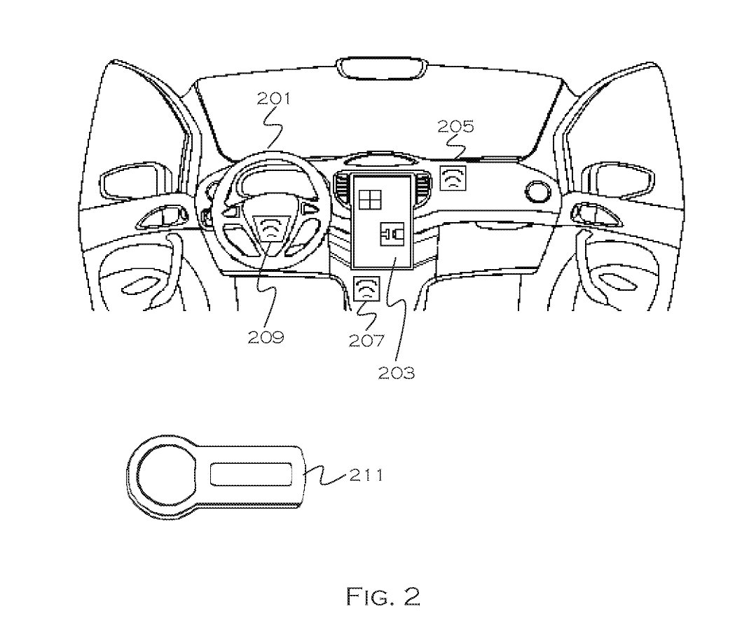

FIG. 2 shows an illustrative vehicle setup, including a telematics tag. In this illustrative example, a vehicle dashboard, center stack and steering wheel are shown. While the engagement receiver is shown in some illustrative locations, it is noted that the receiver could be placed in any reasonable location, which could include rear-seat locations, which might be useful if the user was a passenger in a hired vehicle.

Here, the steering wheel 201 is provided with an illustrative tap-zone 209. In the illustrative embodiment, the user brings the electronic tag 211 in proximity to (or taps the tag to) the tap-zone, in order to engage some form of short range wireless communication between a receiver in the zone and the tag. This communication could take place using, for example, without limitation, near field communication (NFC), BLUETOOTH low energy (BLE), radio frequency identification (RFID) or some other form of short-range communication. In this example, short range communication is used to avoid inadvertent activation (i.e., the user will not likely accidentally engage telematics services), although in other examples the user could press a button, for example, on an electronic tag to engage a longer-range wireless signal, if short-range were not desired. An always-on solution (i.e., a tag persistently broadcasting a longer range signal) is also possible, but accommodation might have to be made to avoid inadvertent pairing, pirating of the signal, varied disengagement of the system (discussed with respect to FIG. 4) and other security concerns.

In this example, a vehicle display 203 in the center stack has another possible tap-zone 207 provided thereto. Another non-limiting example of zone placement could be in the center of the dashboard 205. Any reasonable location for zones is contemplated, including multiple zone placement to facilitate driver and passenger engagement.

In this illustrative example, if the user has rented the vehicle, for example, and is carrying the tag 211 in their pocket, then when the user enters the vehicle, the user can remove the tag from their pocket and place it near an identified tap-zone. This proximity will cause credential information, stored on the electronic tag, to be provided to the vehicle through communication with a receiver in the tap-zone. This credential information can be used to engage telematics services, using an on-board modem stored within the vehicle. In another example, some form of security information could be stored on the tag, usable to retrieve the telematics services information from a remote source (if, for example, it were undesirable to store service information on the tag). Tapping the tag could cause a limited-data-use request to be sent from the telematics modem to the remote site, wherein telematics information could be retrieved, the user verified through a security protocol, if desired, and then the information could be used to provide further telematics services. A verification process could also be used in conjunction with the tag, when appropriate, to prevent a lost tag from providing unlimited telematics services to a finder.

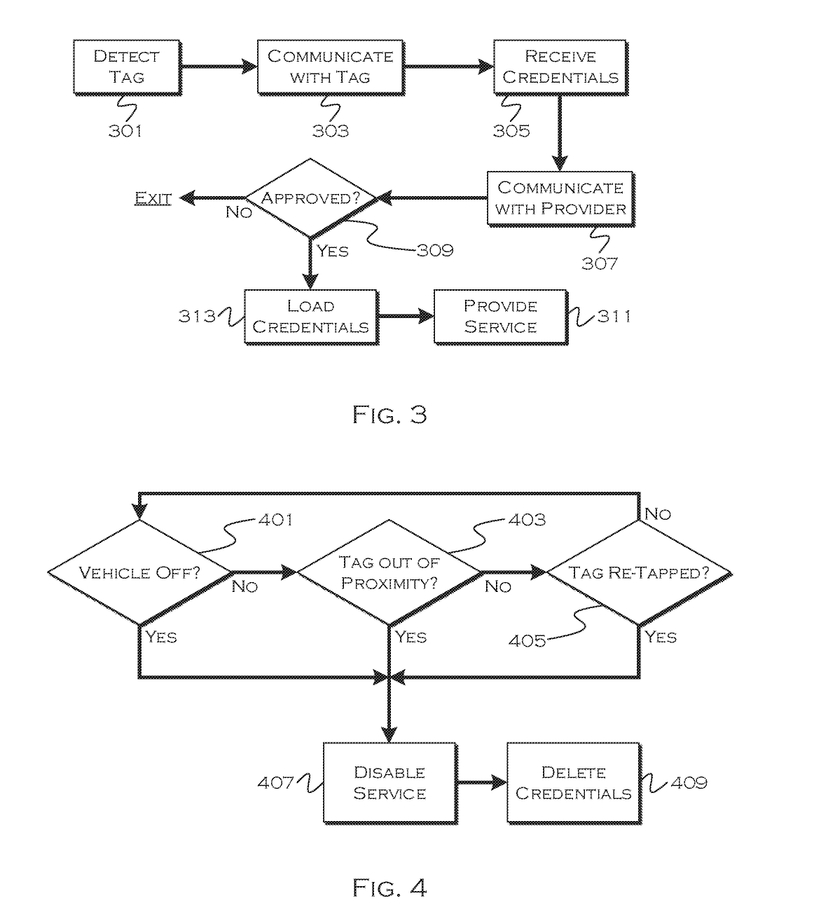

FIG. 3 shows an illustrative process for telematics enablement in a vehicle. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the user will use a tag, containing or providing access to telematics service information, to engage a telematics module in the vehicle. The vehicle telematics module is similar in nature to an unlocked cellular phone, in that it can be provided with some set of service information and being to function using the service information and be enabled to provide services from an identified provider (the modem can be enabled to provide the connection through provision of the credentials to the modem). Typically, the user will purchase the tag from a service provider, and in at least one illustrative example, the tag will contain or provide access to information such as, but not limited to, authentication credentials, a mobile directory number (MDN), billing and other account information. In another example, the tag may store limited information allowing retrieval of the service information from a remote source. In such an instance, to avoid any usage of the vehicle modem that is not approved by a driver, for example, the system could contain some form of limited-use credentials, usable to obtain service for a very short duration, for example, just long enough to transmit the relevant security information and obtain the relevant service provider information for continued telematics use.

The tag may also have a username/password combination associated therewith, which can be verbally or physically input using a vehicle input, or, in another example, a user mobile device can be used to input the verification information once the tag has been engaged. For example, a tag could be engaged and then a verification message could be sent to a user mobile device or email. Only following user verification, including any steps in the message such as inputting a code or similar approval, would the telematics services be engaged, if this particular secure model were employed.

In the illustrative example, the process, running on the vehicle, detects the tap or nearby presence of the electronic tag 301. In response, the process communicates with the tag 303 to obtain telematics-service credentials 305. As previously noted, these could be obtained directly from the tag, or could be obtained from a remote source using information provided by the tag.

The process then communicates with an identified service provider 307. This can allow for approval and verification, as well as any included security measures, such as passwords, verification texts or emails, etc. If the use of the services is approved 309, the process will load the credentials into the telematics module for use in providing telematics services 311. In another example, the credentials may have been already loaded, for use in the verification communication, and will be deleted if the approval is not presented. Telematics services can then be provided through the vehicle 313, using the identified credentials, essentially allowing a user to transfer personal telematics services, tied to an account, from one vehicle to another.

In still another illustrative example, the user could be provided with the telematics tag from an automotive OEM or other service provider. The tag could be writeable (subject to any appropriate security constraints) and the user could flash or write telematics credentials to the tag (after any needed authorizations) from a personal vehicle. This could then enable the tag to provide these same credentials to limited-use vehicles. This could be useful, for example, if a user owned multiple vehicles, having varied levels of telematics services, data usages, etc., applied thereto, and wanted to choose which telematics service to “bring with them” before leaving for a trip in which limited-use vehicles would be used.

FIG. 4 shows an illustrative telematics disablement process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Once a user will be leaving a vehicle, the user will probably not want the telematics services to remain active on that vehicle. Although this could be addressed in some manner by simply deleting the information when a vehicle is powered down, a more proactive user disengagement process may be utilized. If a user is leaving a hired vehicle, for example, it could be hours before the vehicle is actually powered down, and so the telematics services could persist for quite some time on the vehicle. Allowing the user to instruct disengagement of the telematics services can help avoid inadvertent or malicious use of the user's services by another person in the vehicle after the user has left the vehicle.

In this illustrative example, the process checks to see if the vehicle has been turned off 401. This is one criteria for deleting the telematics information, in this example. It may also be the case that this power-off deletion is not included, or is included but is also tied to a time-frame, so that a user renting a vehicle, for example, has limited-persistence of the telematics services without having to re-engage the services each time the vehicle is turned back on. On the other hand, it may be desired to use the power-off deletion to ensure that no inadvertent use of the telematics data occurs. This could be OEM or even user-configurable, and the tag could even include data instructing if and when a particular tag's telematics services are to be disengaged, if desired.

Another consideration made by the process in FIG. 4 is whether or not the tag has left the proximity of the vehicle 403. This consideration will be more useful if the tag utilizes, or is provided with, some form of longer-range wireless communication, since a very close proximity communication capability being the sole communication, may result in such a determination being positive when it should not be (e.g., the user puts the tag back in a pocket, which is out of range for the NFC, and the system inappropriately disengages telematics). By using or including a longer range communication module, which could be provided solely for this purpose, if desired, the process can determine if the user has actually “left” the location of the vehicle and subsequently disengage services. This particular trigger for disengagement is less likely to be used where the sole communication medium is a very short range one, unless the user intends to leave the tag in direct proximity to the receiver for the duration of telematics use.

In still another consideration, the process determines if the tag has been re-tapped to the receiver (or near-proximity has been reestablished) 405. This could be the user affirmatively signaling that a session is over. Although illustrative and non-limiting in nature, these examples show that both passive and explicit disengagement of services can be provided. When any appropriate trigger for disengagement is triggered, the process can disable telematics services 407 and delete any existing credentials 409.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
enable a vehicle modem to provide connectivity for vehicle telematics services based on communication provider account information wirelessly provided to the processor from an electronic tag through a wireless receiver.

2. The system of claim 1, wherein the wireless receiver is a near field communication receiver.

3. The system of claim 1, wherein the wireless receiver is a radio frequency identification receiver.

4. The system of claim 1, wherein the wireless receiver is a BLUETOOTH low energy receiver.

5. The system of claim 1, wherein the communication provider account information includes a cellular service provider identification.

6. The system of claim 1, wherein the processor is further configured to enable the vehicle telematics services after detecting that the electronic tag was brought into detectable proximity to the wireless receiver for a first time.

7. The system of claim 6, wherein the processor is further configured to disable the vehicle telematics services after detecting that the electronic tag was brought into detectable proximity to the wireless receiver for a second time.

8. The system of claim 7, wherein the processor is further configured to delete the communication provider account information from a vehicle memory in conjunction with disabling the vehicle telematics services.

9. The system of claim 1, wherein the processor is configured to delete the communication provider account information from a vehicle memory upon vehicle power-down.

10. The system of claim 1, wherein the processor is configured to delete the communication provider account information when the electronic tag is no longer detectable by the wireless receiver.

11. A computer-implemented method comprising:
detecting an electronic tag in proximity to a vehicle wireless receiver for a first time;
wirelessly receiving communication provider account information from the electronic tag via the vehicle wireless receiver;
providing the communication provider account information to a vehicle telematics module having an onboard modem; and
providing in-vehicle telematics connectivity through the onboard modem using the communication provider account information.

12. The method of claim 11, wirelessly receiving comprising receiving communication provider account information using near field communication.

13. The method of claim 11, wirelessly receiving comprising receiving communication provider account information using radio frequency identification.

14. The method of claim 11, wirelessly receiving comprising receiving communication provider account information using BLUETOOTH low energy.

15. The method of claim 11, further comprising disabling the in-vehicle telematics services after detecting the electronic tag in proximity to the vehicle wireless receiver for a second time.

16. The method of claim 11, further comprising deleting the communication provider account information from a vehicle memory in conjunction with disabling the in-vehicle telematics services.

17. The method of claim 11, further comprising deleting the communication provider account information from a vehicle memory upon vehicle power-down.

18. The method of claim 11, further comprising deleting the communication provider account information when the electronic tag is no longer detectable by the vehicle wireless receiver.

19. A non-transitory computer-readable storage medium storing instructions which, when executed by a processor cause the processor to perform a method comprising:
wirelessly receiving communication provider account information from an electronic tag in detectable proximity to a vehicle wireless receiver;
providing the communication provider account information to a vehicle telematics module having an onboard modem;
providing in-vehicle telematics connectivity through the modem using the communication provider account information; and
deleting the communication provider account information from a vehicle memory upon detection of a predefined deletion condition.

20. The storage medium of claim 19, wherein the predefined deletion condition includes at least one of:
a vehicle power-down;
the electronic tag being brought into detectable proximity for a second time, after leaving detectable proximity; or
the electronic tag leaving detectable proximity.
